(19) United States
(12) Patent Application Publication
(10) Pub. No.: US 2014/0240325 A1
(43) Pub. Date: Aug. 28, 2014

(54) INCREASED EXPANSION PORT UTILIZATION IN A MOTHERBOARD OF A DATA PROCESSING DEVICE BY A GRAPHICS PROCESSING UNIT (GPU) THEREOF

(71) Applicant: NVIDIA Corporation, Santa Clara, CA (US)

(72) Inventors: Mitesh Sharma, Churu (IN); Rohit Surendra Khaire, Pune (IN)

(73) Assignee: NVIDIA Corporation, Santa Clara, CA (US)

(21) Appl. No.: 13/779,764

(22) Filed: Feb. 28, 2013

(51) Int. Cl. G06F 15/80

(52) U.S. Cl. CPC G06F 15/80
USPC 345/502

(57) ABSTRACT

A method includes abstracting, through a driver component, a Graphics Processing Unit (GPU) of a data processing device as a set of GPUs. The GPU is configured to be received in an expansion port on a motherboard of the data processing device. The method also includes enabling, through the abstraction, utilization of a more number of lanes on the expansion port and/or another expansion port on the motherboard of the data processing device than a capability of the GPU otherwise.

### FIELD OF TECHNOLOGY

This disclosure relates generally to data processing devices and, more particularly, to increased expansion port utilization in a motherboard of a data processing device by a Graphics Processing Unit (GPU) thereof.

### BACKGROUND

A data processing device (e.g., a desktop computer, a laptop computer, a server, a laptop computer, a notebook computer, a netbook, a mobile device) may include a Graphics Processing Unit (GPU) configured to be received in an expansion port on a motherboard thereof. The GPU may only have a capability to utilize a number of lanes of the expansion port less than a total number thereof during processing of data therethrough. The data processing device may also include a Central Processing Unit (CPU) communicatively coupled to the GPU and configured to instruct the GPU. The incapability of the GPU to utilize all lanes of the expansion port may render CPU-GPU bandwidth associated with the expansion port sub-optimal.

### SUMMARY

Disclosed are a method, a device and/or a system of increased expansion port utilization in a motherboard of a data processing device by a Graphics Processing Unit (GPU) thereof.

In one aspect, a method includes abstracting, through a driver component, a GPU of a data processing device as a set of GPUs. The GPU is configured to be received in an expansion port on a motherboard of the data processing device. The method also includes enabling, through the abstraction, utilization of a more number of lanes on the expansion port and/or another expansion port on the motherboard of the data processing device than a capability of the GPU otherwise.

In another aspect, a data processing device includes a memory, a GPU communicatively coupled to the memory and configured to be received in an expansion port on a motherboard of the data processing device, and a driver component to abstract the GPU as a set of GPUs. The driver component is configured to enable, through the abstraction, utilization of a more number of lanes on the expansion port and/or another expansion port on the motherboard of the data processing device than a capability of the GPU otherwise.

In yet another aspect, a non-transitory medium, readable through a data processing device and including instructions embodied therein to be executable on the data processing device, is disclosed. The non-transitory medium includes instructions to abstract, through a driver component, a GPU of a data processing device as a set of GPUs. The GPU is configured to be received in an expansion port on a motherboard of the data processing device. The non-transitory medium also includes instructions to enable, through the abstraction, utilization of a more number of lanes on the expansion port and/or another expansion port on the motherboard of the data processing device than a capability of the GPU otherwise.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is an illustrative view of a motherboard of the data processing device of FIG. 1, according to one or more embodiments.

FIG. 3 is a schematic view of an expansion port of the motherboard of the data processing device of FIG. 1, according to one or more embodiments.

FIG. 4 is a schematic view of interaction between a driver component and a Graphics Processing Unit (GPU) of the data processing device of FIG. 1, according to one or more embodiments.

FIG. 5 is an illustrative view of the abstraction of the GPU of the data processing device of FIG. 1 into a set of GPUs, according to one or more embodiments.

FIG. 6 is a process flow diagram detailing the operations involved in increased expansion port utilization in the motherboard of the data processing device of FIG. 1 by the GPU thereof, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of increased expansion port utilization in a motherboard of a data processing device by a Graphics Processing Unit (GPU) thereof. Although the present embodiments have been described with reference to specific example embodiments, it will be evident that various modifications and changes may be made to these embodiments without departing from the broader spirit and scope of the various embodiments.

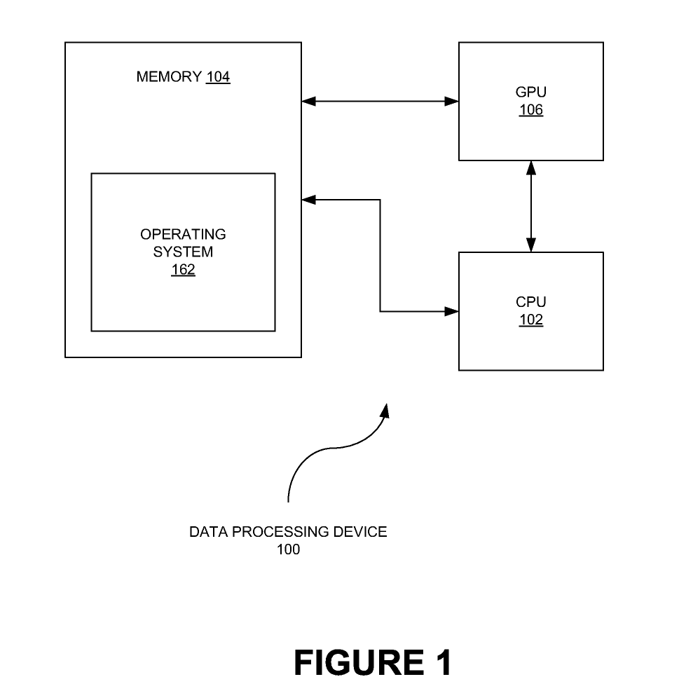

FIG. 1 shows a data processing device 100, according to one or more embodiments. In one or more embodiments, data processing device 100 may include a Central Processing Unit (CPU) 102 communicatively coupled to a memory 104 (e.g., volatile memory, non-volatile memory); memory 104 may include storage locations configured to be addressable through CPU 102. In one or more embodiments, data processing device 100 may be a desktop computer, a laptop computer, a tablet computer, a notebook computer, a netbook, a server or a mobile device such as a mobile phone. Other forms of data processing device 100 are within the scope of the exemplary embodiments. In one or more embodiments, data processing device 100 may include a Graphics Processing Unit (GPU) 106 communicatively coupled to CPU 102 and memory 104. Reference to data processing device 100 will be made below as and when appropriate.

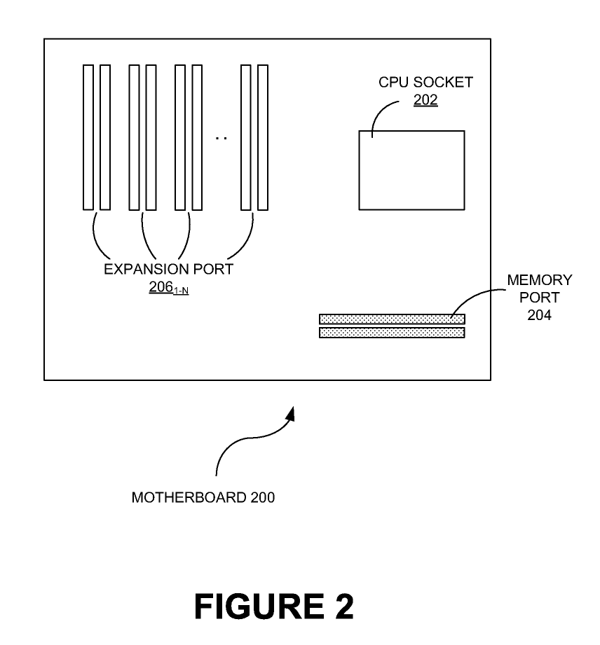

FIG. 2 shows a motherboard 200 of data processing device 100, according to one or more embodiments. In one or more embodiments, motherboard 200 may be the core assembly unit of data processing device 100. In one or more embodiments, motherboard 200 may be configured to receive major components of data processing device 100 including CPU 102 (e.g., through CPU socket 202 therefor). In one or more embodiments, motherboard 200 may also include a memory port 204 configured to receive memory 104 therein. For example, a Random Access Memory (RAM) (example memory 104) may be inserted into memory port 204. Components of motherboard 200 are well known to one of ordinary skill in the art; therefore, detailed discussion of other components has been skipped for the sake of convenience and brevity.

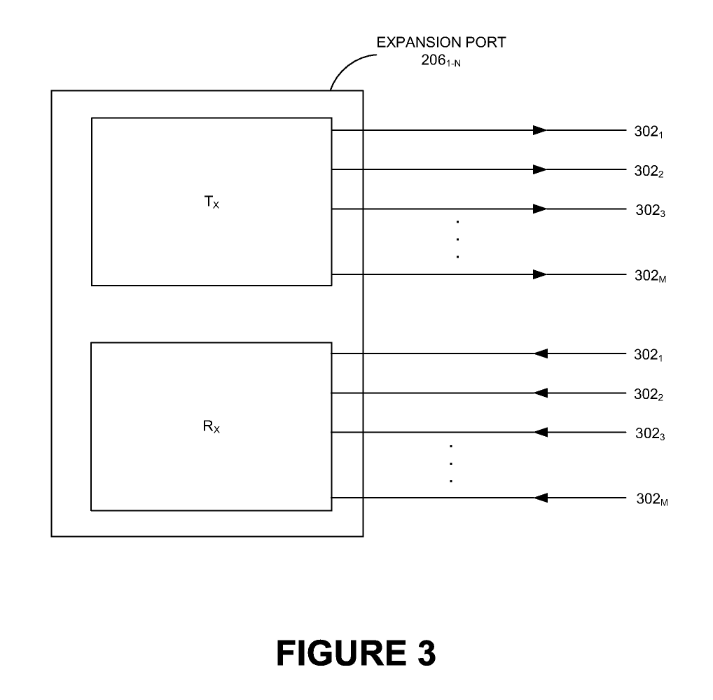

In one or more embodiments, motherboard 200 may include one or more expansion port(s) 206_{1-N}, at least one of which is configured to receive GPU 106. The one or more expansion port(s) 206_{1-N} may, for example, be based on the Peripheral Component Interconnect Express (PCIe) standard. Other standards are within the scope of the exemplary embodiments discussed herein. FIG. 3 shows an expansion port 206_{1-N}, according to one or more embodiments. In one or more embodiments, expansion port 206_{1-N} may include M lanes thereto (e.g., lanes 302_{1-M}; M, for example, may be 32). In one or more embodiments, each lane 302_{1-M} may include two pairs of wires, one each for transmission and reception. Other forms of lanes 302_{1-M} are within the scope of the exemplary embodiments discussed herein.

In one or more embodiments, lanes 302_{1-M} may serve as electrical interconnects between an expansion port 206_{1-N} and a chipset of motherboard 200, between expansion port 206_{1-N} and an expansion switch (e.g., a PCIe switch; not shown) etc. In one or more embodiments, as discussed above, GPU 106 may be coupled to an expansion port 206_{1-N} (e.g., motherboard port, root port); however, GPU 106 may not be able to exploit all of lanes 302_{1-M} associated with expansion port 206_{1-N}. Therefore, in one or more embodiments, CPU-GPU bandwidth associated with expansion port 206_{1-N} may be sub-optimal.

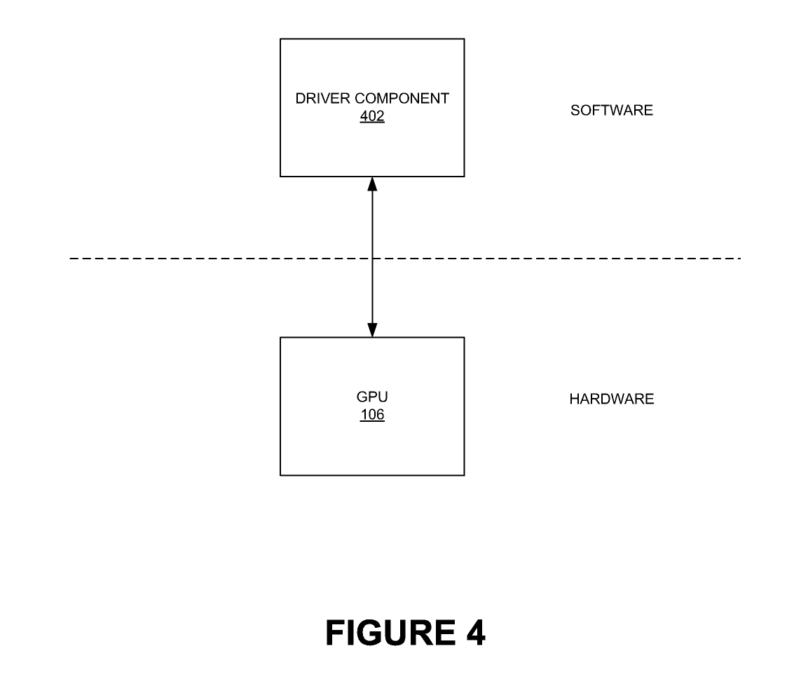

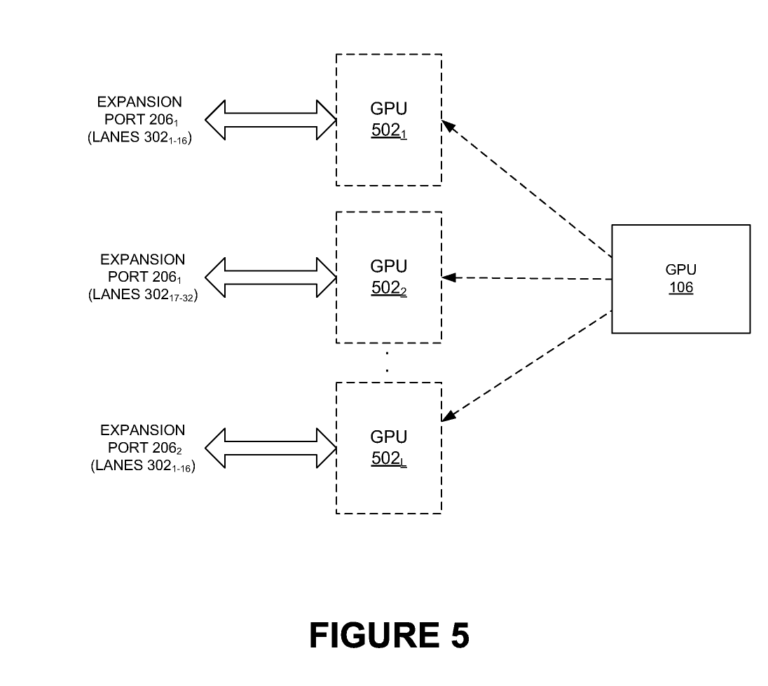

FIG. 4 shows interaction between a driver component 402 and GPU 106, according to one or more embodiments. In one or more embodiments driver component 402 may be a set of instructions configured to have one or more routine(s) thereof invoked by GPU 106. In one or more embodiments, driver component 402 may be part of an application layer in a hierarchy of dataflow; for example, driver component 402 may be provided as an Application Programming Interface (API) to abstract GPU 106 as a set of GPUs (see FIG. 5) utilizing multiple expansion port(s) 206_{1-N}.

In one or more embodiments, driver component 402 may automatically abstract GPU 106 as the set of GPUs; alternately, driver component 402 may be packaged with an application executing on CPU 102 and/or GPU 106, where initiation of execution of the application may trigger abstraction of GPU 106. In an example embodiment of automatic abstraction, driver component 402 may be packaged with an operating system 162 (see FIG. 1; here, driver component 402 may be hardware-specific and/or packaged with libraries compatible with multiple operating systems) executing on data processing device 100; operating system 162 is shown as being stored in memory 104. Instructions associated with driver component 402 may also be available on a non-transitory medium (e.g., Digital Video Disc (DVD), Compact Disc (CD), Blu-ray® disc, hard drive configured to store files associated with driver component 402) readable through data processing device 100.

In one or more embodiments, in accordance with the abstraction, GPU 106 may be provided the capability to transfer data utilizing more lanes 302_{1-M} than a capability thereof otherwise. In one or more embodiments, driver component 402 may enable aggregation of data directed to different GPUs of the set of abstracted GPUs to GPU 106. In one or more embodiments, GPU 106 may perform all processing associated with the interleaved data through operations such as utilizing lanes 302_{1-M} more than a capability thereof otherwise to transmit data as per requirements. In one or more embodiments, GPU 106, therefore, may have more number of lanes 302_{1-M} associated therewith, thereby increasing bandwidth thereof.

FIG. 5 shows the abstraction of GPU 106 into GPUs 502_{1-L} (L>1) for illustrative purposes. As seen in FIG. 5, abstracted GPUs 502_{1-L} may utilize one or more expansion ports 206_{1-N} other than expansion port 206_{1-N} associated with GPU 106 and/or lanes 302_{1-M} beyond capability of GPU 106. Thus, in one or more embodiments, the effect of abstraction may be to increase the number of lanes (e.g., lanes 302_{1-M}) associated with GPU 106 by utilization of more number of lanes of the same expansion port 206_{1-N} and/or utilization of lanes associated with different expansion ports 206_{1-N}. It is obvious that the abovementioned abstraction may provide for increased data bandwidth in data processing device 100.

It should be noted that the abovementioned instructions associated with driver component 402 are not limited to specific embodiments discussed above, and may, for example, be implemented as a foreground or a background process, a network stack or any combination thereof. Other variations are within the scope of the exemplary embodiments discussed herein.

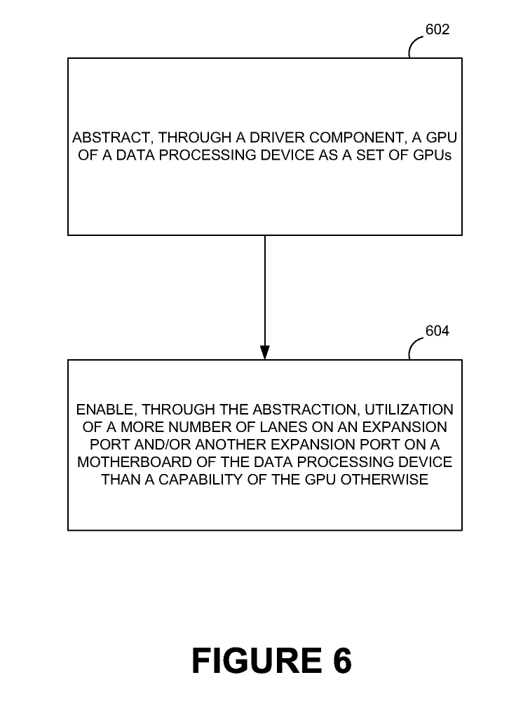

FIG. 6 shows a process flow diagram detailing the operations involved in increased expansion port utilization in motherboard 200 of data processing device 100 by GPU 106 thereof, according to one or more embodiments. In one or more embodiments, operation 602 may involve abstracting, through driver component 402, GPU 106 of a data processing device as a set of GPUs (e.g., GPUs 502_{1-L}). In one or more embodiments, GPU 106 may be configured to be received in an expansion port 206_{1-N} on motherboard 200. In one or more embodiments, operation 604 may then involve enabling, through the abstraction, utilization of a more number of lanes 302_{1-M} on expansion port 206_{1-N} and/or another expansion port 206_{1-N} on motherboard 200 of data processing device 100 than a capability of GPU 106 otherwise.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine-accessible medium compatible with a data processing system (e.g., data processing device 100), and may be performed in any order (e.g., including using means for achieving the various operations).

Accordingly, the specification and drawings are to be regarded in an illustrative rather than a restrictive sense.

What is claimed is:

1. A method comprising:
abstracting, through a driver component, a Graphics Processing Unit (GPU) of a data processing device as a set of GPUs, the GPU being configured to be received in an expansion port on a motherboard of the data processing device; and
enabling, through the abstraction, utilization of a more number of lanes on at least one of the expansion port and another expansion port on the motherboard of the data processing device than a capability of the GPU otherwise.

2. The method of claim 1, further comprising:
transferring, through the driver component in conjunction with a Central Processing Unit (CPU) of the data processing device communicatively coupled to the GPU, data directed to the abstracted set of GPUs to the GPU; and
processing the data transferred to the GPU thereat to enable the utilization of the more number of lanes.

3. The method of claim 1, comprising providing the driver component in association with at least one of the GPU, an application executing on the data processing device and an operating system executing on the data processing device.

4. The method of claim 3, comprising packaging the driver component with appropriate library files to provide for compatibility thereof with a plurality of operating systems including the operating system executing on the data processing device.

5. The method of claim 1, wherein the data processing device is one of a desktop computer, a laptop computer, a notebook computer, a netbook, a server and a mobile device.

6. The method of claim 1, wherein the expansion port is based on a Peripheral Component Interconnect Express (PCIe) standard.

7. The method of claim 3, comprising one of:
automatically abstracting the GPU as the set of GPUs; and
abstracting the GPU as the set of GPUs based on initiation thereof through the application executing on the data processing device.

8. A data processing device comprising:
a memory;
a GPU communicatively coupled to the memory and configured to be received in an expansion port on a motherboard of the data processing device; and
a driver component to abstract the GPU as a set of GPUs, the driver component being configured to enable, through the abstraction, utilization of a more number of lanes on at least one of the expansion port and another expansion port on the motherboard of the data processing device than a capability of the GPU otherwise.

9. The data processing device of claim 8, further comprising a CPU communicatively coupled to the GPU,
wherein the driver component is further configured to transfer, in conjunction with the CPU, data directed to the abstracted set of GPUs to the GPU, and
wherein the GPU is configured to process the data transferred thereto to enable the utilization of the more number of lanes.

10. The data processing device of claim 8, wherein the driver component is provided in association with at least one of the GPU, an application executing on the data processing device and an operating system executing on the data processing device.

11. The data processing device of claim 10, wherein the driver component is packaged with appropriate library files to provide for compatibility thereof with a plurality of operating systems including the operating system executing on the data processing device.

12. The data processing device of claim 8, wherein the data processing device is one of a desktop computer, a laptop computer, a notebook computer, a netbook, a server and a mobile device.

13. The data processing device of claim 8, wherein the expansion port is based on a PCIe standard.

14. The data processing device of claim 10, wherein one of:
the GPU is automatically abstracted as the set of GPUs, and
the GPU is abstracted as the set of GPUs based on initiation thereof through the application executing on the data processing device.

15. A non-transitory medium, readable through a data processing device and including instructions embodied therein to be executable on the data processing device, comprising:
instructions to abstract, through a driver component, a GPU of a data processing device as a set of GPUs, the GPU being configured to be received in an expansion port on a motherboard of the data processing device; and
instructions to enable, through the abstraction, utilization of a more number of lanes on at least one of the expansion port and another expansion port on the motherboard of the data processing device than a capability of the GPU otherwise.

16. The non-transitory medium of claim 15, further comprising:
instructions to transfer, through the driver component in conjunction with a CPU of the data processing device communicatively coupled to the GPU, data directed to the abstracted set of GPUs to the GPU; and
instructions to process the data transferred to the GPU thereat to enable the utilization of the more number of lanes.

17. The non-transitory medium of claim 15, comprising instructions to provide the driver component in association with at least one of the GPU, an application executing on the data processing device and an operating system executing on the data processing device.

18. The non-transitory medium of claim 17, further comprising instructions associated with appropriate library files packaged with the driver component to provide for compatibility thereof with a plurality of operating systems including the operating system executing on the data processing device.

19. The non-transitory medium of claim 15, comprising instructions compatible with the expansion port being based on a PCIe standard.

20. The non-transitory medium of claim 17, comprising one of:
instructions to enable automatic abstraction of the GPU as the set of GPUs; and
instructions to enable abstraction of the GPU as the set of GPUs based on initiation thereof through the application executing on the data processing device.
